(19) United States
(12) Patent Application Publication
(10) Pub. No.: US 2009/0132466 A1
(43) Pub. Date: May 21, 2009

(54) System and method for archiving data

(75) Inventors: Mark R. Etherington, Surbiton (GB); Craig Fear, Lincolnshire (GB)

Correspondence Address: PATENT DOCKET ADMINISTRATOR;LOWENSTEIN SANDLER PC, 65 LIVINGSTON AVENUE, ROSELAND, NJ, 07068, US

(73) Assignee: JP Morgan Chase Bank, New York, NY (US)

(21) Appl. No.: 11/107,646

(22) Filed: Apr. 15, 2005

Related U.S. Application Data
(60) Provisional application No. 60/618,362, filed on Oct. 13, 2004.

(51) Int. Cl. G06F 7/06; G06F 17/30

(52) U.S. Cl. 707/2; 707/101; 707/3; 707/E17.017; 707/E17.002

(57) ABSTRACT

Data to be archived may be stored in a data storage system in a compressed format that allows the compressed data to be accessible without decompression. Along with the data, supporting information is stored in the data storage system. The supporting information may include a location of the data in the storage system and at least one of a schema associated with the data and application information The application information may include a name and version number of an application used to access the data. One or more queries used to access the data may be stored in the storage system or elsewhere. Query attributes also may be stored in the storage system or elsewhere. Query attributes may include a location of a stored query and at least one of data, data formats, and database schemas compatible with a query.

### CROSS-REFERENCE TO RELATED APPLICATION

This application claims the benefit of U.S. Provisional Application No. 60/618,362, filed Oct. 13, 2004, the entire disclosure of which is hereby incorporated herein by reference.

### FIELD OF THE INVENTION

This invention relates to archiving data and associated supplemental information, and allows the archived data to be queried in its archived form and retrieved in real-time, regardless of the archived data's location.

### BACKGROUND OF THE INVENTION

In today's marketplace, organizations record enormous amounts of data in electronic format. Whether the data is customer information, transaction histories, financial information, etc., organizations need an effective solution to store this vast amount of data in a manner that meets their need to retrieve such data. Primarily, there are two factors organizations face when evaluating storage solutions: the cost of data storage media and the speed at which the data may be retrieved from the data storage media. Historically, the cost of a storage medium is directly proportional to the speed at which the data may be retrieved from the storage medium. In other words, a storage medium that allows data to be retrieved quickly typically costs more than a storage medium that allows data to be retrieved more slowly. For example, a hard disk drive provides fast data access as compared to a magnetic tape medium, but is more expensive megabyte per megabyte. Accordingly, organizations conventionally have chosen to store recent data in more expensive and quicker-access storage media, such as a hard disk drive, because recent data has a good chance of being retrieved. For data that is older and, consequently, less likely to be retrieved, organizations conventionally have stored this data in less expensive and slower-access storage media, such as magnetic tape.

Another consideration organizations face when evaluating storage solutions is data compression. Data compression reduces the amount of storage space data requires, but conventionally has increased the amount of time it takes to access the data, because the data must be decompressed before accessing it. Accordingly, organizations conventionally have compressed older data and left more recent data uncompressed. More recently, however, compression techniques have come about that allow certain types of data to be accessed in its compressed form without decompression, thereby allowing organizations to compress data more freely.

In some industries, such as the financial industry, organizations are called upon by governmental agencies to retain data for long periods of time, such as 10 years, and be able to retrieve such historical data in a short time period. Therefore, it has become of paramount importance that these industries be able to retrieve old data quickly. Under the conventional schemes, however, it takes a substantial amount of time to retrieve the historical data from magnetic-tape storage media and to decompress it, if necessary. Further, the historical data may not be readable without a knowledge of the historical data's schema, which takes time to learn, if not known. Further still, the data might require the use of a supporting application that may no longer be readily available in the marketplace. Accordingly, an organization may have to retrieve the data from magnetic tape media, decompress the data, learn the historical data's schema, and acquire and install an antiquated supporting application to access the historical data. This entire process is laborious and time consuming, and unacceptable when the data must be prepared in a short amount of time. Accordingly, a need in the art exists for an efficient solution to storing data that allows it to be retrieved quickly.

### SUMMARY OF THE INVENTION

This problem is addressed and a technical solution achieved in the art by a system and a method for archiving data according to the present invention. According to an embodiment of the invention, data to be archived is stored in a storage system in a compressed format that allows the compressed data to be accessible without having to decompress the data. Because the data is stored in the compressed format and need not be decompressed when retrieving the data, data retrieval time is reduced. The storage system may be a stand-alone or a distributed storage system, and may include one or more computer-accessible memories having a data retrieval time faster than conventional magnetic tape media. By using a distributed storage system, the amount of data stored in the storage system may be substantial, and data may be retrieved from many locations.

In addition to the data to be archived, supporting information is stored in the storage system or elsewhere at a predetermined location. The supporting information may include a location of the data in the storage system and at least one of a schema associated with the data and application information. The application information may include a name and version number of an application used to access the data. Because supporting information is compiled and stored in conjunction with the data, the supporting information need not be compiled at the time of retrieval, when it is more difficult to compile such information. Accordingly, the amount of time needed to retrieve the data is reduced as compared to the conventional schemes.

One or more queries used to access the data may be stored in the storage system or elsewhere at a predetermined location. The queries may be stored in conjunction with the data or may be stored at another time. Query attributes also may be stored in the storage system or elsewhere at a predetermined location. Query attributes may include a location of a stored query and at least one of data, data formats, and database schemas compatible with a query. By storing the one or more queries and the corresponding query attributes, such queries need not be generated at the time of data retrieval, when it is more difficult to do so. Accordingly, the amount of time needed to retrieve the data is reduced as compared to the conventional schemes.

According to an embodiment of the invention, when a request for data stored in the storage system using a query is received, a set of query parameters is determined. The query parameters may include information needed to identify a particular query and particular data upon which to execute the particular query. Once a particular query and its corresponding particular data are determined, the particular query is executed on the particular data with assistance from the stored query attributes and the stored supporting information.

### BRIEF DESCRIPTION OF THE DRAWINGS

The present invention will be more readily understood from the detailed description of preferred embodiments presented below considered in conjunction with the attached drawings, of which:

FIG. 1 illustrates a system for archiving data, according to an embodiment of the present invention;

FIG. 2 illustrates a system for archiving data, according to an embodiment of the present invention;

FIG. 3 illustrates a process of storing data, according to an embodiment of the present invention;

FIG. 4 illustrates a process of storing a query, according to an embodiment of the present invention; and

FIG. 5 illustrates a process of retrieving data, according to an embodiment of the present invention.

It is to be understood that the attached drawings are for purposes of illustrating the concepts of the invention and are not to scale.

### DETAILED DESCRIPTION OF THE INVENTION

The present invention archives a substantial amount of data that may be accessed and retrieved in real-time. The term “real-time” is intended to refer to a duration of time between transmitting a request and receiving a response such that resources are not disproportionately wasted waiting for the response, considering the size of the response and the bandwidth available to receive the response. According to various embodiments of the present invention, real-time retrieval of archived data is achieved by compressing the data in a format that allows the data to be retrieved without decompression; storing the data in a storage system that, advantageously, is a distributed storage system allowing data to be retrieved from various locations; storing supporting information needed to retrieve the data; and storing queries and related attributes used to retrieve the data. Nearly any industry that archives a significant amount of data and has a need to quickly retrieve such data will benefit from the present invention, including, but not limited to, the financial industry, the retail industry, the insurance industry, and the telecom industry.

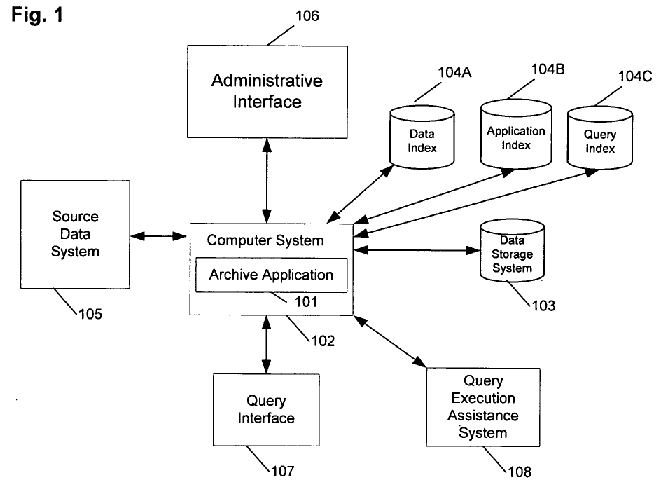

An embodiment of the present invention now will be described with reference to FIG. 1. An archive application 101 manages data storage and retrieval and is executed by one or more computers in a computer system 102. The term “computer” is intended to include any data processing device, such as a desktop computer, a laptop computer, a mainframe computer, a personal digital assistant, a Blackberry, and/or any other device for processing data, and/or managing data, and/or handling data, whether implemented with electrical and/or magnetic and/or optical and/or biological components, or otherwise.

The archive application 101 stores data in and retrieves data from a data storage system 103, which is communicatively connected to the archive application 101 via the computer system 102. In particular, the archive application 101 may store structured data, unstructured data, or both. The phrase “structured data” is intended to include any relational database data, such as, for example, SQL data. The phrase “unstructured data” is intended to include data other than relational database data, such as, for example, data having a word processing program format, such as Microsoft Word, a portable document format (“PDF”), an HTML format, a text file format, an image file format, etc. The archive application 101 also may store queries in the data storage system 103 or in another storage unit communicatively connected to the computer system 102.

The term “communicatively connected” is intended to include any type of connection, whether wired or wireless, between devices and/or programs in which data may be communicated. Further, the term “communicatively connected” is intended to include a connection between devices and/or programs within a single computer, a connection between devices and/or programs located in different computers, or a connection between devices not located in computers at all. In this regard, although the data storage system 103 is shown separately from the computer system 102, one skilled in the art will appreciate that the data storage system 103 may be stored completely or partially within the computer system 102. However, the data storage system 103 may be a distributed storage system including multiple separate computer-accessible memories located in various computers or devices and/or computer-accessible memories communicatively connected to various computers or devices. The data storage system 103 also may reside on one or more computer-accessible memories located within a single computer or device.

The term “computer-accessible memory” is intended to include any computer-accessible data storage device, whether volatile or nonvolatile, electronic, magnetic, optical, or otherwise, including but not limited to, floppy disks, hard disks, CD-ROMs, CD-RWs, DVDs, flash memories, ROMs, and RAMs. However, the data storage system 103 advantageously includes computer-accessible memories having an access time faster than that of conventional magnetic tape media.

A data index 104A is communicatively connected to the archive application 101 via the computer system 102. Although shown separately, the data index 104A may be stored within the data storage system 103. However, the data index 104A may instead be stored elsewhere. The archive application 101 stores supporting information in the data index 104A needed to retrieve data from the data storage system 103. The supporting information may include a location of the data in the data storage system 103 and at least one of a schema associated with the data and application information. The application information may include a name and version number of an application needed to access the data.

Optionally, an application index 104B also is communicatively connected to the archive application 101 via the computer system 102. As with the data index 104A, the application index 104B may be stored within the data storage system 103 or elsewhere. The archive application 101 stores the location of each application needed to access data in the data storage system 103. The applications themselves may be stored in a query execution assistance system (“QEAS”) 108, which may include one or more computers loaded with the applications. Although shown separately, the QEAS 108 may be located within the computer system 102. In this case, the applications needed to access the archived data may be loaded onto the same computer(s) that execute(s) the archive application 101.

It should be noted, however, that if the data storage system 103 stores data of a single type, such as data having an SQL 92 format, known in the art, the application index 104B and the query execution assistance system 108 is not needed, because all data is retrieved in the same manner. However, if the data storage system 103 stores multiple types of data, such as data having an SQL 92 format, and various types of unstructured data, such as PDF documents and Word documents, the application index 104B and the query execution assistance system 108 preferably are included. In this situation, the application index 104B may specify the location of a PDF-document-reading application and a Microsoft-Word-document reading application in the query execution assistance system 108 to retrieve such data from the data storage system 103.

A query index 104C also is communicatively connected to the archive application 101 via the computer system 102. As with the data index 104A and the application index 104B, the query index 104C may be stored within the data storage system 103 or elsewhere. The query application 104C stores query attributes, which may include a location of a stored query and at least one of data, data formats, and database schemas compatible with a query.

A source data system 105 is communicatively connected to the archive application 101 via the computer system 102. The source data system 105 represents various data systems that transmit data to the archive application 101 for storage in the data storage system 103. For example, the source data system 105 may have customer information, transaction histories, financial information, etc., that need to be archived in the data storage system 103.

An administrative interface 106 represents one or more computers communicatively connected to the archive application 101 via the computer system 102, from which one or more administrators interact with, manipulate, and/or configure the archive application 101. The query interface 107 represents one or more computers communicatively connected to the archive application 101 via the computer system 102, from which users or computers (referred to herein as “requesters”) request data stored in the data storage system 103.

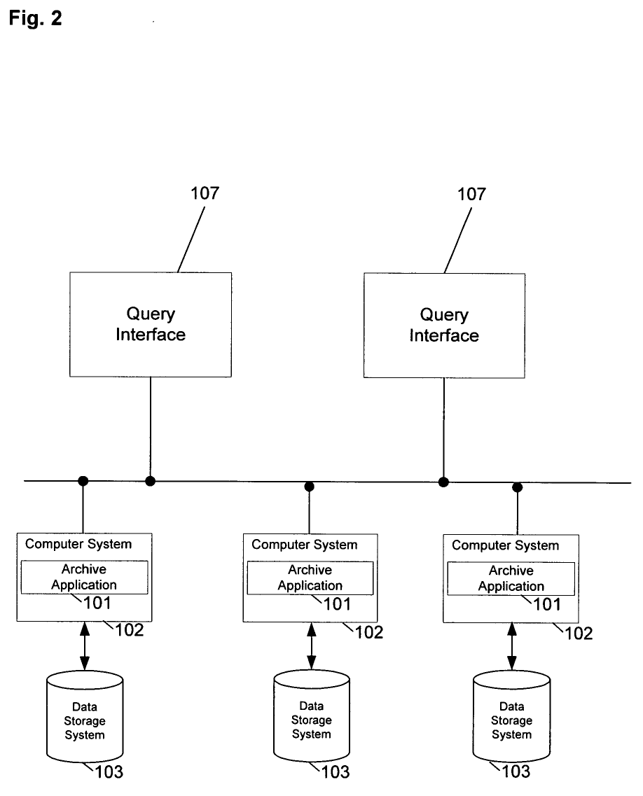

FIG. 2 illustrates an embodiment of the present invention in which a plurality of archive applications 101, executed on their corresponding one or more computers 102, are communicatively connected. According to this embodiment, the plurality of archive applications 101 appear to one or more requesters (not shown), via one or more query interfaces 107, as a single archive system. In other words, a requester transmits a request for data via a query interface 107 that is serviced by the archive application 101 whose data storage system 103 has the requested data. Consequently, the plurality of data storage systems 103 act as a single, combined, data storage system.

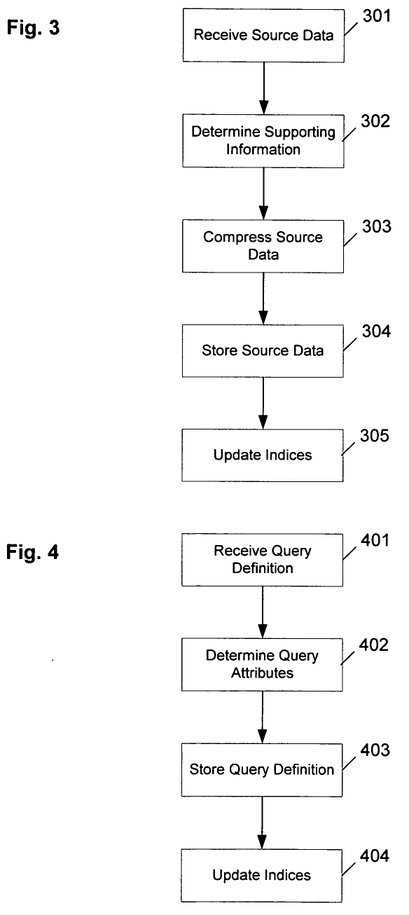

FIG. 3 illustrates a process for archiving data according to an embodiment of the present invention. At step 301, source data to be archived is received from the source data system 105 by the archive application 101. At inception of an archive, the source data system 105 may transmit an entire database dump to the archive application 101 so that an entire database may be archived. After inception, however, the source data system 105 may transmit new data and/or changed data to the archive application 101 for storage in lieu of a database dump, which would likely include a substantial amount of data that already has been archived. Receipt of the source data to be archived at step 301 may occur on a regular schedule or aperiodically.

At step 302, supporting information associated with the source data received at step 301 is determined. The supporting information may include an identifier for the source data to be archived, a description of the source data, a data format associated with the source data, and a schema associated with the source data, if the source data is structured data. For example, assume that the source data received at step 301 is sales data, and the data format of the source data is the SQL 92 format, known in the art. The schema used by the sales data also may be determined at step 302. As is known in the art, schemas may be described graphically or with text, such as SQL code. In this example, the fact that the source data is sales data, the fact that the data format of the source data is SQL 92, and the schema itself, are determined at step 302 to be the supporting information. The supporting information may be determined by the archive application 101 based upon information received from the source data system 105, or based upon a table or other information that associates source data with corresponding supporting information. For example, a table may be used that specifies that all data received from entity X is sales data, has a data format of SQL 92, and has a particular schema “X.”

At step 303, which is optional, the source data is compressed. If the source data is structured data, the source data may be compressed in a format that allows it to be queriable in its compressed format. In other words, the source data may be compressed in a format that allows it to be read without having to be decompressed. An application named Clearpace, known in the art, which compresses SQL data in such a format, may be used.

At step 304, the source data (compressed or uncompressed) is stored in the data storage system 103. The archive application 101 determines a location, or address, of the source data stored in the data storage system 103. This determination may occur based upon a message transmitted from the data storage system 103 to the archive application 101 identifying the location of the source data stored at step 304.

At step 305, the archive application updates the index 104A to specify the identity of the source data stored at step 304, the location of the source data in the data storage system 103, the associated supporting information, as well as creation date and/or date archived information. An example of the contents of the index 104A is shown in Table I.

TABLE I

| Data Identifier | Descrip tion | Data Location | Date Created | Last Archived | Data Format | Schema |
|---|---|---|---|---|---|---|
| Source Data A1 | Sales Data | Address1 | Jan. 10, 1995 | Jan. 10, 1998 | SQL 92 | X |
| Source Data A2 | Sales Data | Address2 | Jan. 10, 1998 | Dec. 31, 2000 | SQL 92 | Y |
| Source Data A3 | Sales Data | Address3 | Jan. 1, 2001 | Mar. 23, 2003 | SQL 92 | Z |
| Source Data B | Handbook | Address4 | Apr. 23, 2003 | Apr. 23, 2003 | Microsoft Word 2000 | — |

Row 1 of Table I illustrates that source data identified as “Source Data A1” is sales data that is stored in the data storage system 103 at the location or address “Address1,” was created on Jan. 10, 1995, was last archived and/or modified on Jan. 10, 1998, has the SQL 92 format, and has a schema of “X.” The “Description” column is optional and may be automatically filled in based upon rules or may be manually filled in by an administrator via the administrative interface 106. Address1 in the “Data Location” column of row 1 represents the location of the Source Data A1 in the data storage system 103. The “Date Created” column identifies the date that the data was created, as opposed to the date that the data was archived. The “Last Archived” column identifies the date that the data was last archived. The “X” in the “schema” column of row 1 may be a link to a file containing a description of the schema.

Similar to row 1, row 2 of Table I illustrates that source data identified as “Source Data A2” is sales data that is stored in the data storage system 103 at the location or address “Address2,” was created on Jan. 10, 1998, was last archived and/or modified on Dec. 31, 2000, has the SQL 92 format, and has a schema of “Y.” The convention used to identify source data in the “Data Identifier” column may be used to associate similar data. For instance, row 1 pertains to the Source Data A1 and row 2 pertains to the Source Data A2. In this example, the “A1” and “A2” in the identifier signifies that the Source Data A1 and the Source Data A2 pertain to similar data differentiated only by a change in schema from X to Y. Stated differently, an organization may have been recording sales data continuously from Jan. 10, 1995 through Dec. 31, 2000. Along the way, however, the organization may have changed the schema for representing the sales data from X to Y on Jan. 10, 1998, as shown in Table I. Accordingly, sales data using the schema X is indexed separately from the sales data using the schema Y. However, because the contents of the separately indexed sales data is the same or similar, the “A1” and “A2” in their respective data identifiers are used as a way to quickly associate them.

Similar to row 2, row 3 of Table I illustrates that source data identified as “Source Data A3” is sales data that is stored in the data storage system 103 at the location or address “Address3,” was created on Jan. 1, 2001, was last archived and/or modified on Mar. 23, 2003, has an SQL 92 format, and has a schema of “Z.” The identifier Source Data A3 indicates that the Source Data A3 is related to the Source Data A1 and the Source Data A2 in rows 1 and 2, respectively, except that it has a schema of “Z.”

Row 4 of Table I illustrates that the source data identified as “Source Data B” is an employee handbook that is stored in the data storage system 103 at the location or address “Address4,” was created on Apr. 23, 2003, has not been modified since, is accessible using MS Word version 2000, and has no schema because it is not a database.

Table I illustrates that the data storage system 103 may store structured data, such as data having the SQL 92 format, unstructured data, such as data having the MS Word 2000 format, or both structured data and unstructured data. However, although the SQL 92 format is used as an example of structured data, one skilled in the art will appreciate that the data storage system 103 may store any kind of structured data for retrieval by the archive application 101. Further, although the MS Word 2000 format is used as an example of unstructured data, one skilled in the art will appreciate that the data storage system 103 may store any kind of unstructured data for retrieval by the archive application 101.

In support of the information stored in the data index 104A, the archive application 101 has access to the application index 104B. The application index 104B identifies a location of each application used to access the data identified in the data index 104A. For instance, if MS Word 2000 is used to access data identified by the data index 104A, MS Word 2000 may be stored on a computer in the Query Execution Assistance System (“QEAS”) 108 awaiting use as necessary. In this case, the application index 104B may identify an address of the location of the MS Word 2000 application in the QEAS 108. An example of data stored in the application index 104B is shown in Table II.

TABLE II

| Application | Version | Location |
|---|---|---|
| Microsoft Word | 2000 | Address L |

Row 1 of Table II illustrates that the application MS Word 2000 is located at address “Address L” in the QEAS 108. It should be noted that no application is needed to access data having the SQL 92 format, because the archive application 101 may directly submit its SQL requests to the data storage system 103 without the assistance of any other application.

In addition to storing source data from the source data system 105, queries used to retrieve the source data from the data storage system 103 also may be stored. Storing queries is particularly useful when a governmental agency requires that particular information be produced from historical data in order to comply with governmental regulations. Because the historical data may be many years old, it has been difficult conventionally to create a query that produces the correct data from historical data. Accordingly, by creating queries that are compatible with today's data and archiving such queries in conjunction with the source data, the queries will not need to be generated at the time of retrieval, many years in the future, when the knowledge base associated with the source data has passed. However, one skilled in the art will appreciate that queries need not be generated and/or stored in conjunction with the source data. To the contrary, queries may be generated and/or stored at any time, and query generation and/or storage may be a process independent of the process of storing source data, described, for example, with reference to FIG. 3.

FIG. 4 illustrates a method for storing a query, according to an embodiment of the present invention. At step 401, a query definition is received by the archive application 101. An administrator may generate the query definition and transmit it to the archive application 101 via the administrative interface 106. However, one skilled in the art will appreciate that the invention is not limited to who or what generates and/or transmits the query definition to the archive application 101.

The query definition may have any number of formats, depending upon the format of the data the query is configured to act upon. For example, if the query is designed to act upon data having the SQL 92 format, the query definition may be a series of SQL statements, and if the query is designed to act upon MS Word files, the query definition may be a program configured to search such files, etc. One skilled in the art will appreciate that the present invention is not limited to the format of the query definition received at step 401.

At step 402, attributes of the query are determined. The query attributes may include at least one of the data, the data formats, and the database schemas that the query is compatible with. For example, the query attributes may specify that the query definition applies to all SQL data having particular schemas; only certain types of SQL data having particular schemas, such as all Sybase Adaptive Server™ Enterprise compatible SQL data having schema “X;” or only a particular set of source data, such as Source Data A1. The query attributes may be determined based upon information received with the query definition at step 401, or may be determined from an analysis of the format of the query definition. For instance, data may be received along with the query definition at step 401 that specifies that the query is compatible with SQL 92 data having schema “X.” Or, the archive application 101 may determine, based upon an analysis of the query definition's format, that it pertains to Microsoft Word data.

At step 403, the query definition is stored. The query definition may be stored in the data storage system 103, in the QEAS 108, or elsewhere. At step 404, the query index 104C is updated to identify the stored query definition, the location of the stored query definition, and the associated query attributes. An example of data stored in the query index 104C is shown in Table III.

TABLE III

| Query Identifier | Applicable Data Format | Schema(s) | Location |
|---|---|---|---|
| Query1A | SQL 92 | X | Address M |
| Query1B | SQL 92 | Y, Z | Address N |
| Query2 | MS Word | — | Address O |

Row 1 of Table III illustrates that a query definition identified by a label, “Query1A,” is compatible with data having the SQL 92 format and the schema “X.” Accordingly, the query definition identified in Row 1 of Table III is compatible with Source Data A1 in Table I, because Source Data A1 is SQL 92 data having schema X. Row 1 of Table III also illustrates that the query definition Query 1A is stored at the location or address “Address M,” which may be a location within the data storage system 103, the QEAS 108, or elsewhere.

Row 2 of Table III illustrates that a query definition identified by a label, “Query1B,” is compatible with SQL 92 data having schema “Y” or schema “Z,” and is stored at the location or address “Address N.” The convention used to identify query definitions in the “Query Identifier” column may link similar queries. For instance, row 1 pertains to the Query 1A and row 2 pertains to the Query 1B. In this example, the “1A” and “1B” in the identifier signifies that the Query 1A and the Query 1B are the same or similar queries, but apply to different schemas. Accordingly, while Query1A applies to Source Data A1 in Table I, Query1B applies to Source Data A2 and Source Data A3 in Table I.

Row 3 of Table III illustrates that a query definition identified by a label, “Query2,” is compatible with MS Word files, regardless of version, and is stored at the location or address, “Address O.” Query2 has no associated schema because MS Word files are not databases. Query2 is compatible with the Source Data B in Table I and may search such data, for example, for particular keywords. As illustrated by Query 2 in row 3 in Table III, which applies to data having any currently existing Microsoft Word format, a query definition may apply to multiple data formats.

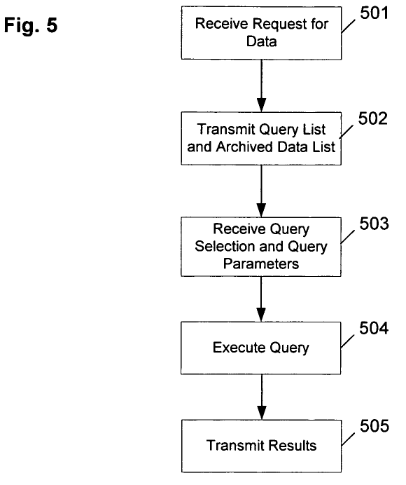

FIG. 5 illustrates a method for retrieving archived data from the data storage system 103, according to an embodiment of the present invention. Although FIG. 5 is described with reference to the use of a query to retrieve data, one skilled in the art will appreciate that queries need not be used to retrieve data and that data may be retrieved from the data storage system 103 directly.

At step 501, a request for data from the data storage system 103 is received by the archive application 101 via the query interface 107. At step 502, the archive application 101 transmits to the requester, via the query interface 107, at least a list of the available queries, as identified by the query index 104C (Table III, for example), and a list of the data stored in the data storage system 103, as identified by the data index 104A (Table I, for example). The query list from index 104C and the data list from the data index 104A may be consolidated when transmitted to the requestor to group similar queries and/or data together. As shown in Table IV, for example, the queries 1A and 1B from Table III may be consolidated into “Query 1”, and the source data A1, A2, and A3 from Table I may be consolidated into “Sales Data.” It should be noted that Tables III and IV are simplified for the purposes of clarity. One skilled in the art however, will appreciate that the invention is not limited to the manner in which the query list and data list are presented to a requester.

TABLE IV

Query List
Query1
Query2
Data List
Sales Data
Handbook

To reduce ambiguity as to which queries are compatible with which data, it is advantageous to present the query list and data list to the request in such a way that compatible queries and data are presented together. For instance, Table IV may be represented alternatively as shown, for example, in Table V.

TABLE V
Query/Data List

Query1 - Sales Data
Query2 - Handbook

At step 503, the archive application 101 receives an indication of which query (“selected query”) is to be executed and the parameters needed to execute the selected query. The query parameters may include information needed to identify a particular query identified in the query index 104C and particular data identified in the data index 104A upon which to execute the particular query. To continue with the example shown in Table IV, the archive application 101 may receive an indication that Query1 should be performed on the Sales Data between May 27, 2001 and Jul. 27, 2001. From this information, the archive application 101 determines that the Query1B shown in Table III must be performed on the Source Data A3 shown in Table I. If a user requests a query and data that are not compatible, the requestor may be presented with an error message.

At step 504, the archive application 101 manages execution of the selected query. The archive application 101 uses the address of the selected query identified in the query index 104C, the address of the selected data identified in the data index 104A, and the address of any application(s) required to perform the query, if necessary, as identified by the application index 104B. For example, if Query2 is to be performed on the Source Data B, the archive application 101 may instruct execution of MS Word, located at Address L, with Query2, located at Address O, on Source Data B, located at Address4.

In an embodiment of the invention, the query execution assistance system (“QEAS”) 108 includes one or more computers that execute the applications identified in the application index 104B. When the archive application 101 executes a query, at step 504, it may transmit the query to a computer in the QEAS 108, and instruct such computer to execute the query on the selected data in the data storage system 103. In some cases, an application identified in the application index 104B is not necessary to execute the query, and, in this case, the archive application 101, may execute the query on the selected data itself. For example, Query1A in Table III, which runs against data having an SQL 92 format, may be executed directly by the archive application 101 without the assistance of any other application.

Upon completion of the query execution, results are transmitted to the archive application 101, either from the data storage system 103 or from the QEAS 108. At step 505, the archive application 101 transmits the results back to the requestor via the query interface 107.

It is to be understood that the exemplary embodiments are merely illustrative of the present invention and that many variations of the above-described embodiments can be devised by one skilled in the art without departing from the scope of the invention. For example, one skilled in the art will appreciate that not all of the process steps illustrated in FIGS. 3-5 are necessary and that such steps need not necessarily be executed in the order shown. In FIG. 3, for example, step 303 is optional, and steps 301 and 302 may occur in reverse order. Further, for example, step 305 need not occur after step 304. In FIG. 4, for example, steps 402 and 403 may be performed in reverse order. Further, for example, step 401 need not occur before step 402, and step 404 need not occur after step 403. In FIG. 5, for example, steps 501 and 502 are optional. The variations described in this paragraph are intended to be merely an illustration of a few possible variations, and are not intended to be an exhaustive list of all possible variations. It is therefore intended that any and all such variations, whether explicitly described or not, be included within the scope of the following claims and their equivalents.

1. A method for archiving structured data, the method comprising the steps of:
storing the structured data, or a derivative thereof, in at least one computer-accessible storage system;
storing supporting information in the storage system, wherein the supporting information comprises a location of the structured data in the storage system and a schema associated with the structured data;
storing query information comprising a query definition used to access the structured data;
compressing the structured data in a format that allows the compressed structured data to be queried without decompression, wherein the compressed structured data is the derivative of the structured data that is stored in the storage system; and
retrieving at least some of the compressed structured data without the decompression based at least upon the supporting information and the query information.

2. (canceled)

3. The method of claim 1, wherein the query information further comprises query attributes.

4. The method of claim 3, wherein the query attributes comprise a location of the stored query definition and at least one of the structured data, a data format, and a schema compatible with the stored query definition.

5. The method of claim 1, further comprising the step of retrieving at least some of the structured data based at least upon the supporting information and the query information.

6. (canceled)

7. (canceled)

8. A computer-accessible memory storing computer code for implementing a method for archiving structured data, wherein the computer code comprises:
code for storing the structured data, or a derivative thereof, in a storage system;
code for storing supporting information in the storage system, wherein the supporting information comprises a location of the structured data in the storage system and a schema associated with the structured data;
code for storing query information comprising a query definition used to access the structured data;
code for compressing the structured data in a format that allows the compressed structured data to be queried without decompression, wherein the compressed structured data is the derivative of the structured data that is stored in the storage system; and
code for retrieving at least some of the compressed structured data without the decompression based at least upon the supporting information and the query information.

9. (canceled)

10. The computer-accessible memory of claim 8, wherein the query information further comprises query attributes.

11. The computer-accessible memory of claim 10, wherein the query attributes comprise a location of the stored query definition and at least one of the structured data, a data format, and a schema compatible with the stored query definition.

12. The computer-accessible memory of claim 8, wherein the computer code further comprises code for retrieving the structured data based at least upon the supporting information and the query information.

13. (canceled)

14. A system for archiving structured data, the system comprising:
at least one storage system comprising a plurality of computer-accessible memories; and
at least one computer system communicatively connected to the storage system, wherein the computer system executes an archive application that instructs the computer system to:
store the structured data, or a derivative thereof, in the storage system; store supporting information in the storage system, wherein the supporting information
comprises a location of the structured data in the storage system and a schema associated with the structured data;
store query information comprising a query definition used to access the structured data;
compress the structured data in a format that allows the compressed structured
data to be queried without decompression, wherein the compressed structured
data is the derivative of the structured data that is stored in the storage system; and
retrieve the compressed structured data without decompression based at least upon the supporting information and the query information.

15. The system of claim 14, wherein the archive application further instructs the computer system to retrieve at least some of the structured data from the storage system based at least upon the supporting information and the query information.

16. (canceled)

17. The system of claim 15, further comprising:
a user computer communicatively connected to the computer system, the user computer operating a user-interface, wherein the user-interface instructs the user computer to transmit a request to the computer system for at least some of the structured data stored in the storage system, and wherein the archive application further instructs the computer system to transmit the retrieved structured data to the user computer in response to the request.

18. The system according to claim 14 that are communicatively connected, such that the structured data may be retrieved from any of the storage systems.

19. The system of claim 14, further comprising:
a user computer communicatively connected to the plurality of the computer systems, the user computer operating a user-interface, wherein the user-interface instructs the user computer to transmit a request to at least one of the plurality of the computer systems, directly or indirectly, for structured data stored in at least one of the storage systems, and wherein at least one of plurality of the computer systems transmits the requested data to the user computer in response to the request.
